(19) United States
(12) Patent Application Publication
(10) Pub. No.: US 2021/0383274 A1
(43) Pub. Date: Dec. 9, 2021

(54) ROBUST LEARNING DEVICE, ROBUST LEARNING METHOD, AND ROBUST LEARNING PROGRAM

(71) Applicant: NEC Corporation, Minato-ku, Tokyo (JP)

(72) Inventors: Tsubasa TAKAHASHI, Tokyo (JP); Hajime ONO, Tokyo (JP)

(73) Assignee: NEC Corporation, Minato-ku, Tokyo (JP)

(21) Appl. No.: 17/286,854

(22) PCT Filed: Oct. 23, 2018
(86) PCT No.: PCT/JP2018/039338

§ 371 Date: Apr. 20, 2021

(51) Int. Cl. G06N 20/00; G06N 3/02; G06K 9/62

(52) U.S. Cl. CPC G06N 20/00; G06K 9/628; G06N 3/02

(57) ABSTRACT

This robust learning device 10 includes a quantity-increasing unit 11 which, in the classification results of a classification model for classifying learning data into one class from among two or more classes, quantity-increases by a predetermined number the highest score among scores for each of the plurality of classes prior to activation of an output layer of the classification model, with the exception of a score for a correct class represented by a correct label with respect to the learning data.

### TECHNICAL FIELD

The present invention relates to a robust learning device, a robust learning method, and a robust learning program, particularly respects to a robust learning device, a robust learning method, and a robust learning program for avoiding artificial intelligence, machine learning models, or classifiers from performing unexpected actions.

### BACKGROUND ART

Machine learning, such as deep learning, does not require manual rule description and feature design, and achieves pattern recognition with high recognition accuracy due to improvements in computer performance and learning algorithms, and performing big data-driven learning, etc.

A learner that performs machine learning, such as deep learning, which uses vast amounts of training data to learn models, can construct artificial intelligence that can determine complex situations. The constructed artificial intelligence is expected to play a central control function in various systems.

The applications required for automated driving are one of the most notable applications where artificial intelligence plays a central control function. Applications required to perform high accuracy biometrics which image or voice recognition is applied are also typical applications in which artificial intelligence plays a central control function.

However, there are vulnerabilities in learned models constructed by machine learning. Specifically, the following problem is known: if an adversarial example (AX), which is an elaborate artificial sample designed to deceive the learned model, is used, a learned model can be induced to perform a malfunction that the designer did not expect during training.

For example, AX is generated in the following way: the target artificial intelligence or classifier for the attack where AX is used is analyzed for how it reacts to the input AX and what it outputs, thereby identifying regions where the target classifier etc. is likely to make mistakes. An artificial sample is then generated to guide the classifier etc. to the identified regions.

Many of the already proposed methods for generating AX are designed with ingenuity to generate AX with small differences from the legitimate sample used by the learner in training to avoid being identified as AX by humans or artificial intelligence.

Other methods of generating AX first obtain information about the training data from which the classifier is generated. There are two ways to obtain information about the training data: using the training data used to learn the classifier, and using a generative or simulation model representing the training data.

Alternatively, one way can make several queries to the classifier and observe or estimate the relationship between input and output in the classifier on the basis of the results of the queries. The methods for obtaining information about the training data are not limited to the above methods.

Then, other methods of generating AX generate AX that may induce misclassification in the classifier, on the basis of the acquired training data.

For example, for a classifier that has learned the task of recognizing traffic signs, an AX to the classifier is an existing sign with a sticker on it that has been elaborately crafted to misclassify it to a specific sign, a sign with certain parts scraped off, or a sign with a trace amount of noise added to it that is unrecognizable to humans.

The above AX intentionally can induce a classifier (artificial intelligence) to misrecognize a sign that humans recognize as a “No Entry” displayed sign, for example, as a sign displaying content other than “No Entry”.

In other words, a classifier constructed in supervised learning, given a set of input samples and a label indicating the correct class to which the input samples are classified as a training data, will misclassify the input AX to a class other than the correct class when an AX slightly different from the input samples is input. In addition, the classifier constructed by supervised learning is loaded with learned models.

That is, AX may be able to induce incident-targeted behavior, such as a malfunction in a system in which a classifier constructed in supervised learning is performing a decision process, or it may cause the system to go out of control.

As a countermeasure to the problems caused by AX, a method of robustly constructing a learning model has been proposed. “Robust” in this specification is the state of a learning model that is unlikely to misclassify AX entered in classes other than the correct class corresponding to the normal sample, even if they are entered with an AX that is slightly different from an arbitrary normal sample.

In other words, a robustly constructed learned model is more likely to correctly classify the input AX into the correct class. In other words, there is no significant difference between the probability that a robustly constructed learned model will classify AX into the correct class and the probability that a robustly constructed learned model will classify the normal sample into the correct class.

Machine learning in which the learned model has a predetermined robustness is hereafter called robust learning. A measure of robustness is known as ε-robustness. If a neural network f_{θ} constructed using training data X satisfies ε-robustness, then for ε (≥0), for any x∈X, for any δ that ∥δ∥₂≤ε, the following equation holds.

arg max f_{θ}(x)ᵢ=arg max f_{θ}(x+δ)ᵢ Equation (1)

Note that θ is a parameter of the neural network f. A neural network f_{θ} satisfying ε-robustness responds consistently contents to ε at least around the training data x∈X. In other words, the neural network f_{θ} is less likely to make misjudgments when AX is entered.

Non Patent Literature(NPL) 1 describes Lipschitz Margin Training (LMT), a method for learning neural networks to satisfy ε-robustness, on the basis of the Lipschitz constant L_{f, θ} which represents how sensitive the neural network is to input.

The LMT introduces the concept of margin M_{f, θ, x}, which is the size of the margin required between the value f_{θ}(x)_{y} of the correct classy in f_{θ}(x), which is the logit of training data x, and the value f_{θ}(x)ᵢ of a class i other than the correct class y.

The logit represents the score for each class before the activation of the output layer of the neural network. In addition, the margin M_{f, θ, x} is defined by the following equation.

M_{f, θ, x}≡f_{θ}(x)_{y}−max_{i≠y} f_{θ}(x)ᵢ Equation (2)

In addition, LMT generates a neural network satisfying ε-robustness by learning that the margin M_{f, θ, x} satisfies the following conditional equation.

M_{f, θ, x}≥2^{1/2}L_{f, θ}ε Equation (3)

Also, instead of the loss function Loss(f_{θ}(x), y), which is computed using the usual f_{θ}(x) and y in a neural network, LMT uses the loss function Loss(f(x)_{y}−εI_{y}, y) where f_{θ}(x) is replaced by f(x)_{y}−βI_{y}.

In addition, β=2^{1/2}L_{f, θ}∥ε∥₂. I_{y} is a vector whose element of the correct class is 1, and other elements is 0. LMT uses the loss function Loss to obtain the margin M_{f, θ, x} that satisfies equation (3).

FIG. 9 is an explanatory diagram showing an example of a robust learning by LMT described in NPL 1. The upper of FIG. 9 shows f_{θ}(x) in the middle of learning. As shown in the upper of FIG. 9, f_{θ}(x) shows outputs for each of classes C1 to C4. In addition, class C2 is the correct class y.

The middle of FIG. 9 shows f_{θ}*(x) with the output suppressed during learning. As shown in the middle of FIG. 9, the LMT suppresses the output for the correct class y. Unless the output f(x)_{y} for the correct class y is greater than or equal to β than the output for the other classes, the neural network cannot output what the correct label indicates with a high probability. In other words, the neural network cannot satisfy ε-robustness.

The lower of FIG. 9 shows the final output f_{θ}(x). Like the reticulated rectangle shown in the lower of FIG. 9, the final output f(x)_{y} for the correct class y is greater than or equal to β than the output for the other classes. When the loss function Loss set up as above is used, robust learning proceeds so that the margin M_{f, θ, x} is greater than or equal to β.

### CITATION LIST

### Non Patent Literature

NPL 1: Yusuke Tsuzuku, Issei Sato, and Masashi Sugiyama, “Lipschitz-Margin Training: Scalable Certification of Perturbation Invariance for Deep Neural Networks,” CoRR abs/1802.04034, 2018.

### SUMMARY OF INVENTION

### Technical Problem

The LMT described above has the problem of slow progress of the executed robust learning. Specifically, supervised learning is required to be executed many times repeatedly until the margins M_{f, θ, x} required to satisfy ε-robustness are obtained. Another problem is that even if supervised learning is performed many times repeatedly, the desired learning results may not be obtained, i.e., the ε-robustness may not be satisfied.

In the following, we consider the suppression of the output for the correct class performed by LMT. The suppressing the output for the correct class performed by LMT can be considered as equivalent to quantity-increasing the output for the classes other than the correct class by the margin M_{f, θ, x}, in other words.

FIG. 10 is an explanatory diagram showing an example of an output suppression in the robust learning by LMT described in NPL 1. The left of FIG. 10 shows f_{θ}*(x) with the output suppressed during learning shown in the middle of FIG. 9.

The right of FIG. 10 shows an example of the quantity-increasing of the margin on the output for classes other than the correct class. In the example shown in the right of FIG. 10, the output for the correct class y is not suppressed. In addition, the output for classes other than the correct class y is quantity-increased a margin of size β, represented by a white rectangle.

The quantity-increasing shown in the right of FIG. 10 corresponds to regularization, which is the learning policy followed by robust learning, which is machine learning. In other words, the robust learning shown in the right of FIG. 10 can be taken as a regularization in which the strength is proportional to the sum of the quantity-increased margins.

Therefore, depending on the magnitude of L_{f, θ} and ε, the regularization to obtain the margin may be too strong. If the regularization becomes too strong, the representational power of the neural network required for robust learning may be excessively suppressed, and the phenomenon that the robust learning do not progress to the stage where ε-robustness is satisfied may occur.

Accordingly, it is an object of the present invention to provide a robust learning device, a robust learning method, and a robust learning program that can reduce the number of iterative learning runs until a classification model becomes robust, which solve the above problems.

### Solution to Problem

The robust learning device according to the present invention includes: a quantity-increasing unit which, in the classification results of a classification model for classifying learning data into one class from among two or more classes, quantity-increases by a predetermined number the highest score among scores for each of the plurality of classes prior to activation of an output layer of the classification model, with the exception of a score for a correct class represented by a correct label with respect to the learning data.

The robust learning method according to the present invention includes: in the classification results of a classification model for classifying learning data into one class from among two or more classes, quantity-increasing by a predetermined number the highest score among scores for each of the plurality of classes prior to activation of an output layer of the classification model, with the exception of a score for a correct class represented by a correct label with respect to the learning data.

The robust learning program according to the present invention causes a computer to execute: a quantity-increasing process of, in the classification results of a classification model for classifying learning data into one class from among two or more classes, quantity-increasing by a predetermined number the highest score among scores for each of the plurality of classes prior to activation of an output layer of the classification model, with the exception of a score for a correct class represented by a correct label with respect to the learning data.

### Advantageous Effects of Invention

The present invention can reduce the number of iterative learning runs until a classification model becomes robust.

### BRIEF DESCRIPTION OF DRAWINGS

FIG. 1 is a block diagram showing a configuration example of a robust learning device according to a first exemplary embodiment of the present invention.

FIG. 2 is an explanatory diagram showing an example of an output for a predetermined class is quantity-increased by a quantity-increasing unit 120.

FIG. 3 is a flowchart showing the operation of the robust learning process by a robust learning device 100 of the first exemplary embodiment.

FIG. 4 is a graph showing the size of the margin obtained by the learning method executed in the robust learning device 100 and the size of the margin obtained by the learning method described in NPL 1.

FIG. 5 is a graph showing the classification accuracy for AX of a classifier learned by the learning method executed in the robust learning device 100 and the classification accuracy for AX of a classifier learned by the learning method described in NPL 1.

FIG. 6 is a graph showing the magnitude of losses computed by the learning method executed in the robust learning device 100 and the magnitude of losses computed by the learning method described in NPL 1.

FIG. 7 is an explanatory diagram showing a hardware configuration example of a robust learning device according to the present invention.

FIG. 8 is a block diagram showing an outline of a robust learning device according to the present invention.

FIG. 9 is an explanatory diagram showing an example of a robust learning by LMT described in NPL 1.

FIG. 10 is an explanatory diagram showing an example of an output suppression in the robust learning by LMT described in NPL 1.

### DESCRIPTION OF EMBODIMENTS

Exemplary embodiments of the present invention will now be described below with reference to the drawings.

Each drawing describes an exemplary embodiment of the present invention. However, the present invention is not limited to the description in each drawing. In addition, similar configurations in each drawing may be numbered identically and their repeated description may be omitted.

Also, in the drawings used in the following description, the description of the configuration of the parts not related to the description of the present invention may be omitted and may not be shown.

### First Exemplary Embodiment

[Description of Configuration]

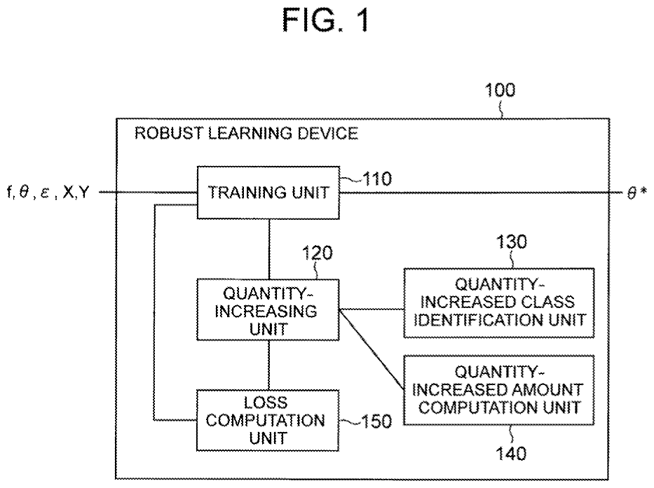

FIG. 1 is a block diagram showing a configuration example of a robust learning device according to a first exemplary embodiment of the present invention.

As mentioned above, if the regularization is too strong to obtain the margin required for the ε-robustness to be satisfied, the neural network will not be able to satisfy the ε-robustness, even if robust learning is performed. Alternatively, in robust learning, supervised learning may be repeated many times until the ε-robustness is satisfied.

The robust learning device 100 of this exemplary embodiment can solve the above problem. The robust learning device 100, which can solve the above problem, provides a method of robustness of a machine learning model for AX to avoid the classifier from performing unexpected actions due to AX, which is input data that would deceive a classifier constructed with artificial intelligence, especially machine learning.

As shown in FIG. 1, the robust learning device 100 has a training unit 110, a quantity-increasing unit 120, a quantity-increased class identification unit 130, a quantity-increased amount computation unit 140, and a loss computation unit 150. An overview of each unit is as follows.

The robust learning device 100 accepts as input the neural network f, the parameter θ, the robustness magnitude of the learning target ε, the training data X, and the correct label Y, respectively. The accepted inputs are first passed to the training unit 110.

The neural network f, parameter θ, training data X, and the correct label Y are not limited in particular to the input. In addition, cross entropy may be used as the loss function Loss of the neural network f. Also, relu may be used for the activation functions of the input layer of the neural network f, and softmax may be used for the activation functions of the output layer of the neural network f, respectively.

The training unit 110 performs supervised learning (hereafter also referred to as simply learning) on the neural network f so that the training data X is associated to the correct label Y, using the neural network f, the parameter θ, the training data X, and the correct label Y.

The training unit 110 computes the loss from supervised learning using the quantity-increasing unit 120 and the loss computation unit 150. The training unit 110 then performs learning to increase the probability of outputting the correct label Y from the training data X by performing error inverse propagation.

The quantity-increasing unit 120 quantity-increases the output for a predetermined class of f_{θ}(x), the value of logit obtained from x∈X, by the amount required for ε-robustness to be satisfied. The quantity-increasing unit 120 determines the class for which the output of f_{θ}(x) is quantity-increased, using the quantity-increased class identification unit 130. The quantity-increasing unit 120 also determines the amount to be quantity-increased using the quantity-increased amount computation unit 140.

The quantity-increased class identification unit 130 identifies the class that outputs the largest value among the classes other than the correct class y in the values of logit f_{θ}(x) obtained from x∈X. In other words, the quantity-increased class identification unit 130 performs the following computation.

j=arg max_{j≠y} f_{θ}(x)ⱼ Equation (4)

The quantity-increasing unit 120 receives the class j whose output is quantity-increased from the quantity-increased class identification unit 130 and generates a vector Iⱼ. The vector Iⱼ is a vector in which only the j-th element is 1 and the other elements are 0.

The quantity-increased amount computation unit 140 also derives the Lipschitz constants L_{f, θ} from the neural network f and the parameter θ in the same way as described in NPL 1. Then, the quantity-increased amount computation unit 140 computes an amount to be quantity-increased β, which is the size of the margin required for ε-robustness to be satisfied, as follows.

β=2^{1/2}L_{f,θ}ε Equation (5)

The quantity-increasing unit 120 receives the amount to be quantity-increased β from the quantity-increased amount computation unit 140. The quantity-increasing unit 120 computes the following formula using the vector Iⱼ and the amount to be quantity-increased β.

f_{θ}*(x)=f_{θ}(x)+βIⱼ Equation (6)

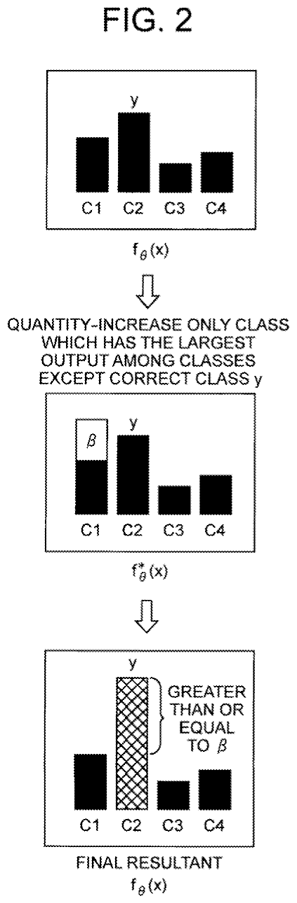

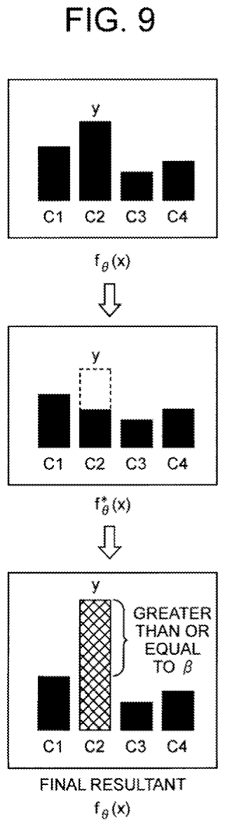

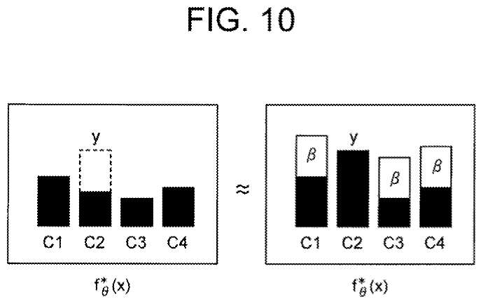

FIG. 2 is an explanatory diagram showing an example of an output for a predetermined class is quantity-increased by a quantity-increasing unit 120. The upper of FIG. 2 shows f_{θ}(x) during learning shown in the upper of FIG. 9.

The quantity-increasing unit 120 receives information indicating that the class in which the output is quantity-increased is class C1 from the quantity-increased class identification unit 130. The quantity-increasing unit 120 also receives the amount to be quantity-increased β from the quantity-increased amount computation unit 140.

The middle of FIG. 2 shows the f_{θ}*(x) with the output quantity-increased for class C1. As shown in the middle of FIG. 2, the quantity-increasing unit 120 quantity-increases only the class C1, which has the largest output among the classes except the correct class C2.

The lower of FIG. 2 shows the final resultant f_{θ}(x). Like the reticulated rectangle shown in the lower of FIG. 2, the final output f(x)_{y} for the correct class y(C2) shows a value greater than or equal to β than the outputs for the other classes. The f_{θ}(x) shown in the lower of FIG. 2 is the expected learning result that will eventually be obtained as the quantity-increasing is performed.

The loss computation unit 150 computes the loss function Loss(f_{θ}*(x), y) using f_{θ}*(x), which is the logit that the quantity-increasing unit 120 performed the quantity-increasing. The training unit 110 performs an error inverse propagation to minimize the value of the computed loss function, for example.

The robust learning device 100 of this exemplary embodiment repeats the operation described above to complete the robust learning. The robust learning device 100 then outputs the parameter θ* of the neural network f for which the robust learning is completed.

The sum of the amount that the robust learning device 100 of this exemplary embodiment quantity-increases is less than or equal to the sum of the amount that the LMT quantity-increases as described in NPL 1.

For example, if the number of classes classified by the neural network f is m(≥2), then the sum of the amount that the LMT quantity-increases is (m−1)β. In addition, the sum of the amount that the robust learning device 100 of this exemplary embodiment quantity-increases is always β.

Therefore, if m>2, the strength of regularization by the robust learning device 100 of this exemplary embodiment is always less than the strength of regularization by the LMT. In addition, when m=2, the strength of regularization by both methods is equal.

Both the robust learning device 100 of this exemplary embodiment and the LMT can make the difference between the output regarding the correct class and the output regarding the classes other than the correct class more than β. Therefore, the robust learning device 100 of this exemplary embodiment can perform a weaker regularization than the regularization by the LMT to achieve a robust learning that brings about a robustness effect equivalent to the effect of the LMT.

As an overview of the above process, the robust learning device 100 of this exemplary embodiment performs robust learning on a classification model that classifies learning data into one class from among two or more classes.

The robust learning device 100 includes a quantity-increasing unit 120 which, in the classification results of a classification model, quantity-increases by a predetermined number the highest score among scores for each of the plurality of classes prior to activation of an output layer of the classification model, with the exception of a score for a correct class represented by a correct label with respect to the learning data.

[Description of Operation]

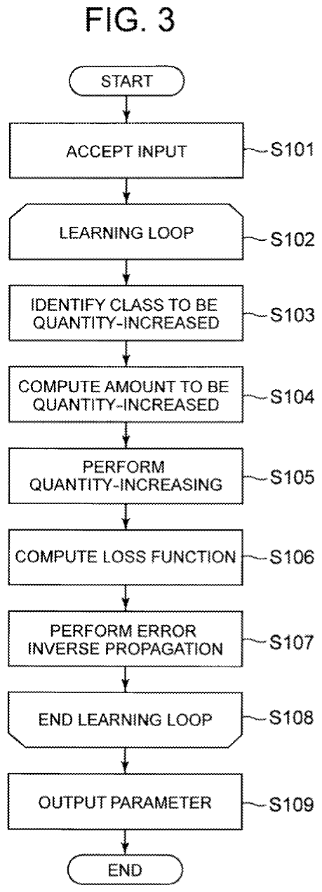

The operation of performing robust learning of the robust learning device 100 of the present exemplary embodiment will be described below with reference to FIG. 3. FIG. 3 is a flowchart showing the operation of the robust learning process by a robust learning device 100 of the first exemplary embodiment.

First, the training unit 110 accepts as input the neural network f, the parameter θ, the robustness magnitude of the learning target ε, the training data X, and the correct label Y, respectively (step S101).

Next, the training unit 110 performs robust learning on the neural network f. That is, the training unit 110 enters a learning loop (step S102).

The quantity-increasing unit 120 instructs the quantity-increased class identification unit 130 to identify the class whose output is quantity-increased. Upon receiving the instruction, the quantity-increased class identification unit 130 identifies the class whose output has the largest value among the classes other than the correct class y among the values of logit f_{θ}(x) obtained from x∈X (step S103). The quantity-increased class identification unit 130 then inputs the information indicating the class whose output is quantity-increased to the quantity-increasing unit 120.

The quantity-increasing unit 120 then instructs the quantity-increased amount computation unit 140 to compute the amount by which the output for the class identified in step S103 is quantity-increased.

Upon receiving the instruction, the quantity-increased amount computation unit 140 computes an amount β to be quantity-increased, which is the size of the margin required for ε-robustness to be satisfied, according to equation (5) (step S104). Next, the quantity-increased amount computation unit 140 inputs the amount β by which the output is quantity-increased to the quantity-increasing unit 120.

Next, the quantity-increasing unit 120 performs the computation shown in equation (6) using the vector computed on the basis of the information input from the quantity-increased class identification unit 130 and the amount to be quantity-increased β input from the quantity-increased amount computation unit 140. That is, the quantity-increasing unit 120 performs the quantity-increasing of the output with respect to a predetermined class (step S105).

The loss computation unit 150 then computes the loss function Loss(f_{θ}*(x), y) on the basis of f_{θ}*(x), which is the logit that the quantity-increasing unit 120 has performed the quantity-increasing (step S106). The loss computation unit 150 inputs the computed loss function Loss(f_{θ}*(x), y) to the training unit 110.

The training unit 110 then performs supervised learning on the neural network f so that the training data X is associated to the correct label Y. In this example, the training unit 110 performs an error inverse propagation so that the value of the input loss function Loss(f_{θ}*(x), y) is minimized (step S107).

The processes of steps S103 to S107 is repeated while the predetermined condition corresponding to the completion of robust learning is not satisfied. The predetermined condition is, for example, that the difference between the output for the correct class y and the output for a class other than the correct class y is β or greater.

When the predetermined condition is satisfied, the training unit 110 exits the learning loop (step S108). Next, the training unit 110 outputs the parameter θ* of the neural network f at the stage of exiting the learning loop (step S109). After outputting the parameters, the robust learning device 100 ends the robust learning process.

[Description of Effects]

The robust learning device 100 of this exemplary embodiment includes a training unit 110 that performs supervised learning so that the training data X is associated to the correct label Y using the neural network f, the parameter θ, the magnitude of the robustness of the learning target ε, the training data X, and the correct label Y as inputs.

The robust learning device 100 also includes a quantity-increasing unit 120 that quantity-increases the output with respect to a predetermined class for the results learned by the training unit 110, and a quantity-increased class identification unit 130 that identifies the class to be quantity-increased.

The robust learning device 100 also includes a quantity-increased amount computation unit 140 that computes the amount of quantity-increasing based on the Lipschitz constant L_{f, θ} derived from the neural network f and parameter θ and the magnitude of robustness ε, and a loss computation unit 150 that computes the loss for the logit in which the quantity-increasing is performed.

As a countermeasure to AX, there is a problem that when robust learning is performed where the learning model can satisfy ε-robustness, the regularization is too strong to obtain the required margin for ε-robustness to be satisfied. If the regularization for obtaining the margin is too strong, there is a problem that either robust learning cannot be completed or supervised learning is required to be repeated until the ε-robustness is satisfied.

The robust learning device 100 of this exemplary embodiment does not make regularization to obtain a margin too strong because the quantity-increasing unit 120 quantity-increases only for the class that outputs the largest value among the classes other than the correct class. Therefore, the robust learning device 100 can reduce the number of supervised learning that is repeated in robust learning where ε-robustness is satisfied. In addition, the robust learning device 100 can provide a higher degree of robustness that existing robust learning cannot provide.

### EXAMPLE

The results of the experiments in which the robust learning device 100 of the first exemplary embodiment was used are described in this example below. In this example, the learning method executed by the robust learning device 100 is referred to as LC-LMT and the learning method described in NPL 1 is referred to as LMT, respectively.

First, we will describe an overview of the experiment. The data set used in the experiment is the MNIST (Mixed National Institute of Standards and Technology database), which is an image data set of handwritten numbers from 0 to 9.

As the neural network f_{θ}, we used a network consisting of four fully connected layers (number of parameters: 100, activation function: Relu) and one fully connected layer (number of outputs: 10, activation function: softmax). Also, we used cross entropy as the loss function Loss.

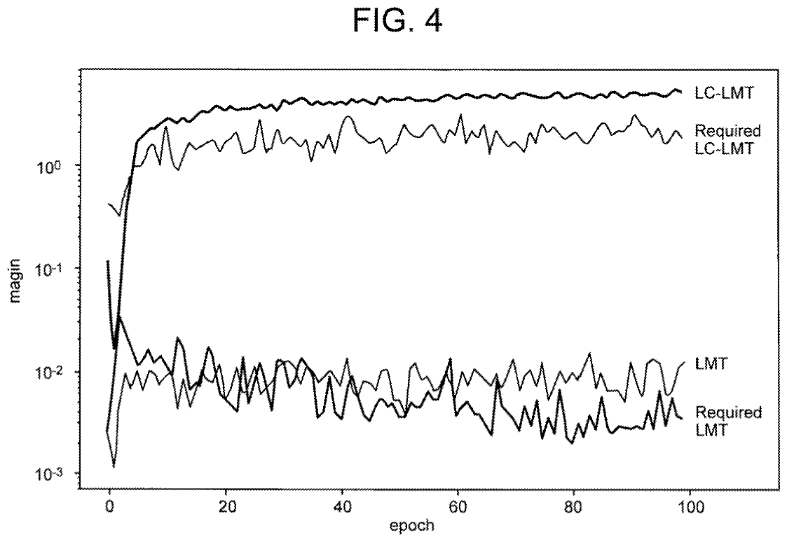

FIG. 4 is a graph showing the size of the margin obtained by the learning method executed in the robust learning device 100 and the size of the margin obtained by the learning method described in NPL 1. In the example shown in FIG. 4, both LC-LMT and LMT perform robust learning so that 2-robust is satisfied.

The “LC-LMT” shown in the graph in FIG. 4 represents the size of the margin obtained by the LC-LMT. The “LMT” represents the size of the margin obtained by the LMT. In the graph in FIG. 4, the size of the margin obtained by LC-LMT and the size of the margin obtained by LMT are plotted for each epoch, which is the number of times supervised learning was repeated.

The “Required LC-LMT” shown in the graph in FIG. 4 represents the size of the margin required for ε-robustness to be satisfied in the neural network after supervised learning has been performed by the LC-LMT. The “Required LMT” shown in the graph in FIG. 4 represents the size of the margin required for ε-robustness to be satisfied in the neural network after supervised learning has been performed by the LMT.

Referring to the graph in FIG. 4, the LC-LMT, which is a learning method by the robust learning device 100, obtains a margin larger than a margin required for the ε-robustness to be satisfied in a smaller number of epochs than the LMT. In other words, the LC-LMT can complete robust learning where ε-robustness is satisfied earlier than the LMT.

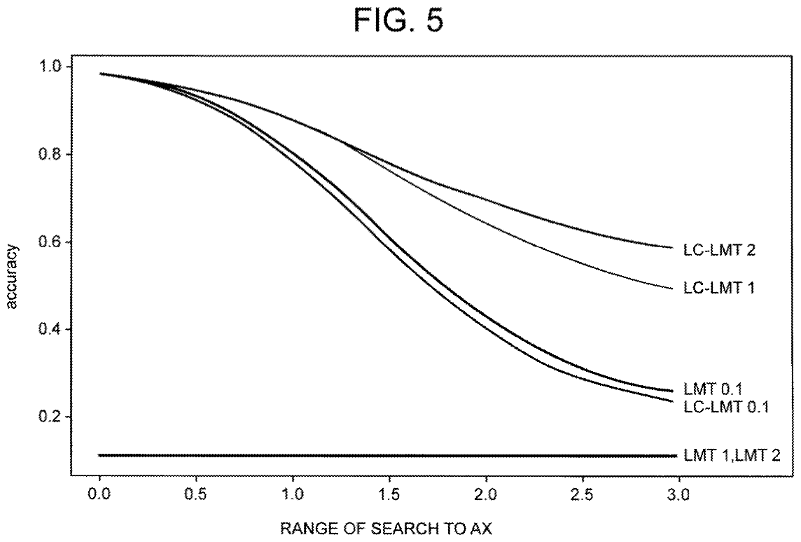

FIG. 5 is a graph showing the classification accuracy for AX of a classifier learned by the learning method executed in the robust learning device 100 and the classification accuracy for AX of a classifier learned by the learning method described in NPL 1.

The graph in FIG. 5 shows the percentage(Accuracy) of AX correctly classified by LC-LMT-learned classifier and LMT-learned classifier, respectively. The graph in FIG. 5 plots the Accuracy of the classifiers learned by each method up to 100 epochs.

The legend shown in FIG. 5 also describes, in order, the name of the method and the magnitude of ε used for robust learning. For example, the “LC-LMT 0.1” shown in the graph in FIG. 5 represents the percentage of AX correctly classified by the classifier in which LC-LMT performed robust learning so that 0.1-robust is satisfied.

The horizontal axis of the graph in FIG. 5 also represents the range of searches used to generate AX. The Accuracy that was evaluated using AX is plotted. The larger the value on the horizontal axis, the greater the range to be searched from and the more likely to be confused with the normal sample AX is used. Note that Accuracy for the value “0” on the horizontal axis is the percentage of correct responses to the input of the normal sample.

Referring to the graph in FIG. 5, classifiers that are performed robust learning by LC-LMT satisfying ε=1 or ε=2 are able to classify AX more correctly than classifiers that are performed robust learning by LMT satisfying ε=1 or ε=2. That is, a classifier that is performed robust learning by LC-LMT will be a more robust classifier.

Also, referring to the graph in FIG. 5, a classifier that is performed robust learning by LMT satisfying ε=1 or ε=2 cannot correctly classify even the input non-AX normal sample. That is, even if robust learning is performed, ε-robustness is not sufficiently satisfied.

In other words, when the number of epochs is the same, the robustness of a classifier that is performed robust learning by the robust learning device 100 of this exemplary embodiment is more robust than the robustness of a classifier that is performed robust learning by LMT.

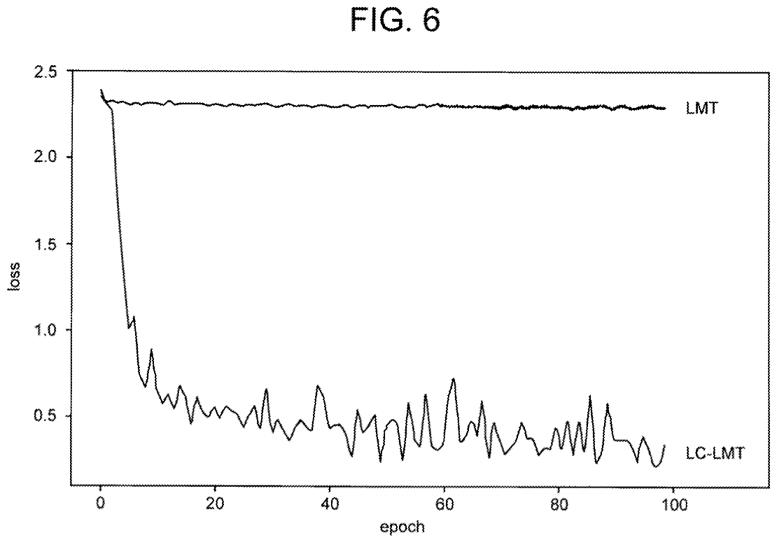

FIG. 6 is a graph showing the magnitude of losses computed by the learning method executed in the robust learning device 100 and the magnitude of losses computed by the learning method described in NPL 1. In the example shown in FIG. 6, both LC-LMT and LMT perform robust learning so that 2-robust is satisfied.

The “LC-LMT” shown in the graph in FIG. 6 represents the magnitude of loss Loss in each epoch in robust learning by LC-LMT. Also, “LMT” represents the magnitude of loss Loss in each epoch in robust learning by LMT.

Referring to the graph in FIG. 6, we can see that in robust learning by LMT, the loss is almost unchanged regardless of the number of epochs. The fact that the loss is almost unchanged regardless of the number of epochs means that the classification error does not decrease at all, no matter how many times supervised learning is performed. In other words, robust learning by LMT does not acquire the classification accuracy that should be acquired by the classifier by trying to obtain a margin, originally. Therefore, it is likely that robust learning to obtain a margin while maintaining the classification accuracy of the classifier has not been achieved.

Symmetrically, robust learning by LC-LMT reduces the loss while the epoch number is small, referring to the graph in FIG. 6. In other words, LC-LMT can suppress the strength of regularization to the extent that robust learning is sufficiently advanced.

The results of the experiments shown in FIGS. 4-6 mean that the number of iterative performed supervised learning is reduced in the robust learning performed by the robust learning device 100 of this exemplary embodiment where ε-robustness is satisfied. In addition, the results of the experiments shown in FIGS. 4-6 mean that higher robustness, which cannot be obtained with existing robust learning, can be obtained with the robust learning performed by the robust learning device 100 of this exemplary embodiment.

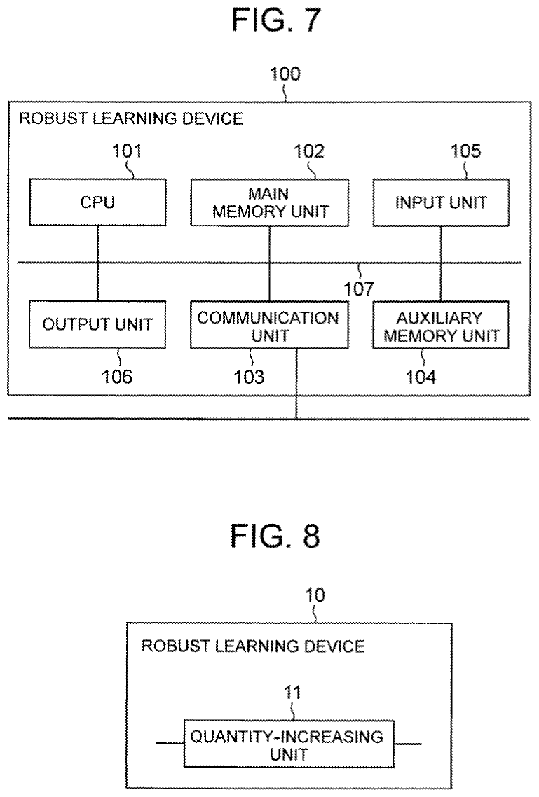

A specific example of the hardware configuration of the robust learning device 100 of the present exemplary embodiment will be described below. FIG. 7 is an explanatory diagram showing a hardware configuration example of a robust learning device according to the present invention.

The robust learning device 100 shown in FIG. 7 has a central processing unit (CPU) 101, a main memory unit 102, a communication unit 103, and an auxiliary memory unit 104. It may also be equipped with an input unit 105 for user operation and an output unit 106 for presenting a processing result or progress of the processing content to the user. The robust learning device 100 shown in FIG. 7 may be realized as a computer device.

The robust learning device 100 shown in FIG. 7 may be equipped with a DSP (Digital Signal Processor) or GPU (Graphical Processing Unit) instead of the CPU 101. Alternatively, the robust learning device 100 shown in FIG. 7 may be equipped with a CPU 101, a DSP, and a GPU together.

The main memory unit 102 is used as a working area for data and a temporary storage area for data. For example, the main memory unit 102 temporarily stores programs and data to be executed by the CPU 101. The main memory unit 102 is a RAM, such as Dynamic Random Access Memory (D-RAM), for example.

The communication unit 103 has a function to input and output data to and from peripheral devices via a wired network or a wireless network (information and communication network).

The communication unit 103 may also use a network interface circuit (NIC), which relays data to and from an external device (not shown) via a communication network. NIC is a Local Area Network (LAN) card, for example.

The auxiliary memory unit 104 is a non-temporary, tangible storage medium. Non-temporary tangible storage media include, for example, magnetic disks, optical magnetic disks, CD-ROM (Compact Disk Read Only Memory), DVD-ROM (Digital Versatile Disk Read Only Memory), P-ROM (Programmable Read Only Memory), Flash ROM (Read Only Memory), and semiconductor memory.

The input unit 105 has a function to input data and processing instructions. The input unit 105 receives input instructions from an operator of the robust learning device 100, for example. The input unit 105 is an input device, such as a keyboard, mouse, or touch panel, for example.

The output unit 106 has a function to output data. The output unit 106 displays information to an operator of the robust learning device 100, for example. The output unit 106 is a display device, such as a liquid crystal display device, or a printing device, such as a printer, for example.

Also, as shown in FIG. 7, in the robust learning device 100, each component is connected to the system bus 107.

The auxiliary memory unit 104 stores programs to realize, for example, a training unit 110, a quantity-increasing unit 120, a quantity-increased class identification unit 130, a quantity-increased amount computation unit 140, and a loss computation unit 150. The auxiliary memory unit 104 may also store fixed data.

The robust learning device 100 may be realized by hardware. For example, the robust learning device 100 may be implemented with a circuit that includes hardware components such as LSI (Large Scale Integration) which programs that realize functions as shown in FIG. 1 are incorporated into inside.

The robust learning device 100 may also be realized by software, by executing a program in which the CPU 101 shown in FIG. 7 provides the functions that each component has.

If realized by software, each function is realized by software by CPU 101 loading and executing the program stored in auxiliary memory unit 104 into main memory unit 102 and controlling the operation of robust learning device 100.

Alternatively, the CPU 101 may read the program from a storage medium (not shown) that stores the program in a computer-readable manner, using a storage medium reader (not shown). Alternatively, the CPU 101 may receive the program from an external device (not shown) via the input unit 105, store it in the main memory unit 102, and operate on the basis of the stored program.

The robust learning device 100 may also have an internal storage device that stores data and programs to be stored over time. The internal storage device operates as a temporary storage device for example, the CPU 101. The internal storage device may be, for example, a hard disk device, a magneto-optical disk device, a solid state drive (SSD), or a disk array device.

The auxiliary memory unit 104 and internal storage device are non-volatile (non-transitory) storage media. Also, the main memory unit 102 is volatile (transitory) storage media. The CPU 101 is operable on the basis of programs stored in the auxiliary memory unit 104, internal storage device, or the main memory unit 102. That is, the CPU 101 is operable using a non-volatile storage medium, or volatile storage medium.

The robust learning device 100 may also have an Input/Output Circuit (IOC), which mediates data exchanged between the CPU 101 and the input unit 105/the output unit 106. The IOC may be, for example, an IO interface card, or a Universal Serial Bus (USB) card.

Also, some or all of each component may be realized by a general-purpose circuit (circuitry) or dedicated circuits, processors, etc. or a combination of these. They may be configured by a single chip or by multiple chips connected via a bus. Some or all of each component may be realized by a combination of the above-mentioned circuitry, etc. and programs.

When some or all of each component is realized by a plurality of information processing devices, circuits and the like, the plurality of information processing devices, circuits and the like may be centrally located or distributed. For example, the information processing devices and circuits may be realized as the embodiment where each component is connected via a communication network, such as a client-and-server system, a cloud computing system.

Next, an overview of the present invention will be described. FIG. 8 is a block diagram showing an outline of a robust learning device according to the present invention. The robust learning device 10 according to the invention includes a quantity-increasing unit 11 (e.g., quantity-increasing unit 120) that, in the classification results of a classification model for classifying learning data into one class from among two or more classes, quantity-increases by a predetermined number the highest score among scores for each of the plurality of classes prior to activation of an output layer of the classification model, with the exception of a score for a correct class represented by a correct label with respect to the learning data.

With such a configuration, a robust learning device can reduce the number of iterative learning runs until a classification model becomes robust.

The robust learning device 10 also perform supervised learning on the classification model using the quantity-increased classification results, the learning data, and the correct label for the learning data (e.g., training unit 110).

With such a configuration, a robust learning device can provide a classification model with higher robustness.

The robust learning device 10 may also include a first computation unit (e.g., a loss computation unit 150) that computes the loss function on the basis of the quantity-increased classification results, and the learning unit may perform supervised learning using the computed loss function.

With such a configuration, the robust learning device can advance robust learning by performing error inverse propagation to minimize the value of the computed loss function.

The robust learning device 10 may also include a second computation unit (e.g., quantity-increased amount computation unit 140) that computes the predetermined number on the basis of the Lipschitz constant and the magnitude of robustness.

With such a configuration, the robust learning device can advance robust learning on the basis of the sensitivities that the neural network has to the input.

The robust learning device 10 may also include an identification unit (e.g., quantity-increased class identification unit 130) that identifies the class with the highest score in the classification results, with the exception of the score for the correct class represented by the correct label with respect to the learning data.

With such a configuration, the robust learning device can identify the class that outputs the largest value of the value of logit f_{θ}(x) among the classes other than the correct classy.

The classification model may also be a neural network.

With such a configuration, the robust learning device can provide a neural network with higher robustness.

The robust learning device 10 may also take as input the neural network f, the parameter θ, the robustness magnitude of the learning target ε, the training data X, and the correct label Y. The learning unit uses the training data X and the correct label Y to perform supervised learning.

The quantity-increasing unit 11 also quantity-increases on the classification result by the neural network f learned by the learning unit. The second computation unit also computes a predetermined number on the basis of the Lipschitz constants L_{f, θ} and the magnitude of robustness ε derived from the neural network f and the parameter θ. The first computation unit also computes the loss function using logit which is the quantity-increased classification result.

The robust learning device 10 can reduce the number of iterations of supervised learning in robust learning where ε-robustness is satisfied. In addition, the robust learning performed by the robust learning device 10 provides a higher degree of robustness than can be obtained with existing robust learning.

Although the present invention has been described above with reference to exemplary embodiments, the present invention is not limited to the above exemplary embodiments. The configuration and details of the present invention can be modified in various ways that are understandable to those skilled in the art within the scope of the present invention.

### REFERENCE SIGNS LIST

10, 100 Robust learning device

11, 120 Quantity-increasing unit

101 CPU

102 Main memory unit

103 Communication unit

104 Auxiliary memory unit

105 Input unit

106 Output unit

107 System bus

110 Training unit

130 Quantity-increased class identification unit

140 Quantity-increased amount computation unit

150 Loss computation unit

What is claimed is:

1. A robust learning device comprising:
a quantity-increasing unit which, in the classification results of a classification model for classifying learning data into one class from among two or more classes, quantity-increases by a predetermined number the highest score among scores for each of the plurality of classes prior to activation of an output layer of the classification model, with the exception of a score for a correct class represented by a correct label with respect to the learning data.

2. The robust learning device according to claim 1, comprising a learning unit which performs supervised learning on the classification model using the quantity-increased classification results, the learning data, and the correct label for the learning data.

3. The robust learning device according to claim 2, comprising a first computation unit which computes the loss function on the basis of the quantity-increased classification results,
wherein the learning unit performs supervised learning using the computed loss function.

4. The robust learning device according to claim 1, comprising a second computation unit which computes the predetermined number on the basis of the Lipschitz constant and the magnitude of robustness.

5. The robust learning device according to claim 1, comprising an identification unit which identifies the class with the highest score in the classification results, with the exception of the score for the correct class represented by the correct label with respect to the learning data.

6. The robust learning device according to claim 1, wherein the classification model is a neural network.

7. A robust learning method comprising:
in the classification results of a classification model for classifying learning data into one class from among two or more classes, quantity-increasing by a predetermined number the highest score among scores for each of the plurality of classes prior to activation of an output layer of the classification model, with the exception of a score for a correct class represented by a correct label with respect to the learning data.

8. The robust learning method according to claim 7, comprising
performing supervised learning on the classification model using the quantity-increased classification results, the learning data, and the correct label for the learning data.

9. A non-transitory computer-readable capturing medium having captured therein a robust learning program for causing a computer to execute:
a quantity-increasing process of, in the classification results of a classification model for classifying learning data into one class from among two or more classes, quantity-increasing by a predetermined number the highest score among scores for each of the plurality of classes prior to activation of an output layer of the classification model, with the exception of a score for a correct class represented by a correct label with respect to the learning data.

10. The medium having captured therein the robust learning program according to claim 9, causing a computer to:
execute a learning process of performing supervised learning on the classification model using the quantity-increased classification results, the learning data, and the correct label for the learning data.

11. The robust learning device according to claim 2, comprising a second computation unit which computes the predetermined number on the basis of the Lipschitz constant and the magnitude of robustness.

12. The robust learning device according to claim 3, comprising a second computation unit which computes the predetermined number on the basis of the Lipschitz constant and the magnitude of robustness.

13. The robust learning device according to claim 2, comprising an identification unit which identifies the class with the highest score in the classification results, with the exception of the score for the correct class represented by the correct label with respect to the learning data.

14. The robust learning device according to claim 3, comprising an identification unit which identifies the class with the highest score in the classification results, with the exception of the score for the correct class represented by the correct label with respect to the learning data.

15. The robust learning device according to claim 4, comprising an identification unit which identifies the class with the highest score in the classification results, with the exception of the score for the correct class represented by the correct label with respect to the learning data.

16. The robust learning device according to claim 11, comprising an identification unit which identifies the class with the highest score in the classification results, with the exception of the score for the correct class represented by the correct label with respect to the learning data.

17. The robust learning device according to claim 12, comprising an identification unit which identifies the class with the highest score in the classification results, with the exception of the score for the correct class represented by the correct label with respect to the learning data.

18. The robust learning device according to claim 2, wherein the classification model is a neural network.

19. The robust learning device according to claim 3, wherein the classification model is a neural network.

20. The robust learning device according to claim 4, wherein the classification model is a neural network.
